(19) United States
(12) Patent Application Publication
(10) Pub. No.: US 2023/0208209 A1
(43) Pub. Date: Jun. 29, 2023

(54) MAGNETIC ATTRACTION STRUCTURE FOR WIRELESS CHARGING DEVICE OR TERMINAL DEVICE AND WIRELESS CHARGING DEVICE

(71) Applicant: Primax Electronics Ltd., Taipei (TW)

(72) Inventor: Xin-Liang Chang, Taipei (TW)

(21) Appl. No.: 17/576,232

(22) Filed: Jan. 14, 2022

(30) Foreign Application Priority Data
Dec. 28, 2021 (CN) 202111623150.4

(51) Int. Cl. H02J 50/90; H02J 50/10; H01F 7/20

(52) U.S. Cl. CPC H02J 50/90; H02J 50/10; H01F 7/206; H02J 2310/22; H01F 2007/208

(57) ABSTRACT

A magnetic attraction structure for a wireless charging device or a terminal device is provided, which includes one or more electromagnets. The electromagnet includes an iron core and a winding group. The iron core includes a first plate, a second plate and a connecting part. The first plate is separated from the second plate by a distance, and the connecting part is connected between the first plate and the second plate, and the winding group surrounds the connecting part. A side surface of a long side of the first plate and a side surface of a long side of the second plate are configured to face a cover plate of the wireless charging device or a cover plate of the terminal device. A wireless charging device including the above-mentioned magnetic attraction structure is also provided.

### FIELD OF THE INVENTION

The present invention relates to a magnetic attraction structure for a wireless charging device or a terminal device and a wireless charging device including the magnetic attraction structure.

### BACKGROUND OF THE INVENTION

A current common wireless charging mode is to place a terminal device on a charging device for charging. However, the terminal device may move or even fall due to a non-static environment (e.g., in a moving car), and thus it cannot be effectively charged. Therefore, how to provide a suitable temporary fixing method between the terminal device and the charging device has become a technical issue in this field.

### SUMMARY OF THE INVENTION

The present disclosure provides a magnetic attraction structure for a wireless charging device or a terminal device, which includes one or more electromagnets. The electromagnet includes an iron core and a winding group. The iron core includes a first plate, a second plate and a connecting part. The first plate is separated from the second plate by a distance, and the connecting part is connected between the first plate and the second plate, and the winding group surrounds the connecting part. A side surface of a long side of the first plate and a side surface of a long side of the second plate are configured to face a cover plate of the wireless charging device or a cover plate of the terminal device.

In some embodiments of the present invention, the electromagnet is I-shaped in a cross section perpendicular to a plane direction of the first plate and a plane direction of the second plate.

In some embodiments of the present invention, the winding group has a plurality of coils connected in series or in parallel.

In some embodiments of the present invention, the one or more electromagnets are the electromagnets, and the electromagnets are connected to each other to form a ring-shaped electromagnet.

In some embodiments of the present invention, the first plates of the electromagnets are connected to each other to form a first ring-shaped plate, and the second plates of the electromagnets are connected to each other to form a second ring-shaped plate.

In some embodiments of the present invention, the one or more electromagnets are the electromagnets, and the electromagnets are arranged to form a plurality of arc-shaped electromagnets surrounding a region.

In some embodiments of the present invention, the magnetic attraction structure further includes one or more permanent magnets, wherein the one or more electromagnets are the electromagnets, and the one or more permanent magnets are disposed between two adjacent of the electromagnets.

In some embodiments of the present invention, the electromagnets and the one or more permanent magnets are arranged to form a ring-shaped magnetic attraction structure.

In some embodiments of the present invention, one of the one or more permanent magnets is adjacent to a side surface of a short side of the first plate of one of the electromagnets and a side surface of a short side of the second plate of the one of the electromagnets.

The present disclosure further provides a wireless charging device, which includes the above-mentioned magnetic attraction structure, a cover plate, a charging module and a bottom plate. The cover plate is disposed over the magnetic attraction structure and configured to face a terminal device. The charging module is laterally adjacent to the magnetic attraction structure. The bottom plate is disposed beneath the magnetic attraction structure and the charging module.

In some embodiments of the present invention, the charging module is surrounded by the magnetic attraction structure, and the charging module includes: a charging coil close to the cover plate; a ferrite magnetic sheet disposed beneath the charging coil; and a printed circuit board assembly (PCBA) disposed beneath the ferrite magnetic sheet.

### BRIEF DESCRIPTION OF THE DRAWINGS

FIG. 1 is a three-dimensional schematic diagram of an electromagnet according to an embodiment of the present invention.

FIG. 2 is a schematic diagram of electrical connection of coils of a winding group according to an embodiment of the present invention.

FIG. 3 is a schematic diagram of electrical connection of coils of a winding group according to an embodiment of the present invention.

FIG. 4 is a schematic top view of a ring-shaped electromagnet according to an embodiment of the present invention.

FIG. 5 is a schematic top view of arc-shaped electromagnets according to an embodiment of the present invention.

FIG. 6 is a schematic top view of a ring-shaped magnetic attraction structure according to an embodiment of the present invention.

FIG. 7 is an exploded view of a wireless charging device and a terminal device according to an embodiment of the present invention.

### DETAIL DESCRIPTION OF THE PREFERRED EMBODIMENT

The advantages and features of the present invention and the method for achieving the same will be described in more detail with reference to exemplary embodiments and the accompanying drawings to make it easier to understand. However, the present invention can be implemented in different forms and should not be construed as being limited to the embodiments set forth herein. On the contrary, for those skilled in the art, the provided embodiments will make this disclosure more thorough, comprehensive and complete to convey the scope of the present invention.

The spatially relative terms in the text, such as “beneath” and “over”, are used to facilitate the description of the relative relationship between one element or feature and another element or feature in the drawings. The true meaning of the spatially relative terms includes other orientations. For example, when the drawing is flipped up and down by 180 degrees, the relationship between the one element and the other element may change from “beneath” to “over.” The spatially relative descriptions used herein should be interpreted the same.

As mentioned in the background of the invention, the terminal device may move or even fall due to the non-static environment (e.g., in the moving car), and thus it cannot be effectively charged. Therefore, how to provide the suitable temporary fixing method between the terminal device and the charging device has become the technical issue in this field. Accordingly, the present invention provides a magnetic attraction structure that can be used in the wireless charging device and/or the terminal device to solve the above technical issue. In particular, attraction force of the magnetic attraction structure can be adjusted, so it can be applied to the terminal device without a protective shell (which does not require too much attraction force) or the terminal device with a protective shell (which requires larger attraction force). Also, the attraction force of the magnetic structure can be adjusted according to actual needs, such as daily use (which does not require too much attraction force) or placed in a car (which requires larger attraction force). Various embodiments of the magnetic attraction structure of the present invention will be described in detail below.

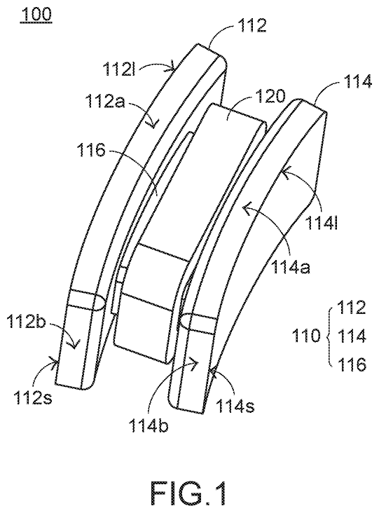

FIG. 1 is a three-dimensional schematic diagram of an electromagnet according to an embodiment of the present invention. As shown in FIG. 1, the magnetic attraction structure used for the wireless charging device or the terminal device includes one or more electromagnets 100. The electromagnet 100 includes an iron core 110 and a winding group 120. The iron core 110 includes a first plate 112, a second plate 114 and a connecting part 116. The first plate 112 and the second plate 114 are separated by a distance. The connecting part 116 is connected between the first plate 112 and the second plate 114. The winding group 120 surrounds the connecting part 116. In some embodiments, the first plate 112 and the second plate 114 are substantially parallel to each other.

In some embodiments, each of the first plate and the second plate is arc-shaped, flat, or has another shape. In one embodiment, as shown in FIG. 1, the first plate 112 and the second plate 114 are arc-shaped. In some embodiments, from a side view of FIG. 1, the shape of the first plate and the shape of the second plate may be any shape, such as an angular shape (e.g., a square or a rectangle), a circle, or an ellipse. In one embodiment, as shown in FIG. 1, the shape of the first plate 112 is a rectangle, which has a long side 112l and a short side 112s; the shape of the second plate 114 is also a rectangle, which has a long side 114l and a short side 114s.

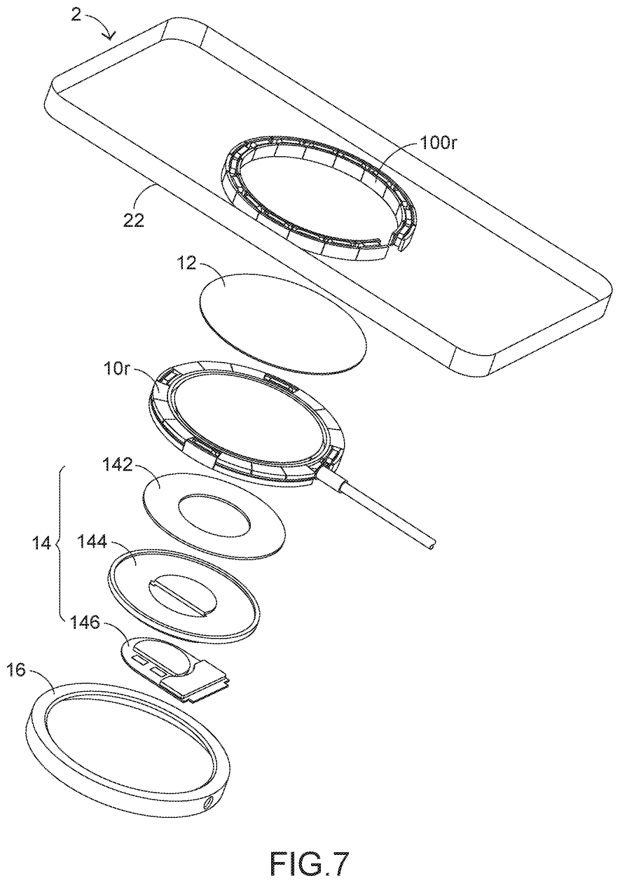

A side surface 112a of the long side 112l of the first plate 112 (or may be referred to as a thickness surface) and a side surface 114a of the long side 114l of the second plate 114 (or may be referred to as a thickness surface) may be configured to face a cover plate of the wireless charging device (e.g., a cover plate 12 of a wireless charging device shown in FIG. 7) or a cover plate of the terminal device (e.g., a cover plate 22 of a terminal device 2 shown in FIG. 7). However, the present invention is not limited to the above-mentioned embodiment. In another embodiment, the shape of the first plate is a square (not shown), which has four edges of the same length. Each of the four edges can be regarded as the aforementioned long side, and a side surface of any of the four edges (or may be referred to as a thickness surface) is configured to face the cover plate of the wireless charging device or the cover plate of the terminal device.

In some embodiments, as shown in FIG. 1, length and width of the connecting part 116 are smaller than length and width of the first plate 112 and length and width of the second plate 114. In some embodiments, the electromagnet 100 is I-shaped in a cross section perpendicular to a plane direction of the first plate 112 and a plane direction the second plate 114. The term “cross section” mentioned here is the plane perpendicular to the plane where the first plate 112 is located and the plane where the second plate 114 is located.

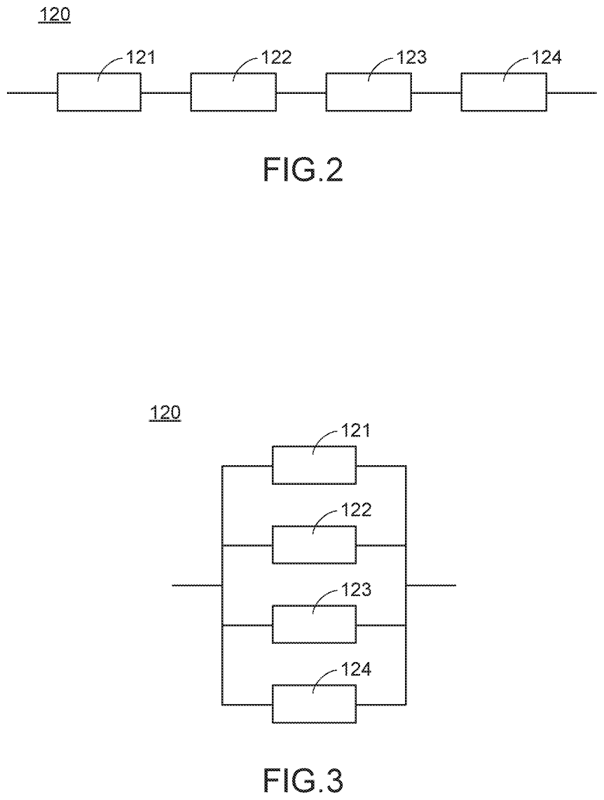

In some embodiments, the winding group 120 has a plurality of coils, and the coils are connected in series or in parallel. Number and material of the coils can be adjusted according to actual needs. FIG. 2 is a schematic diagram of electrical connection of coils of a winding group according to an embodiment of the present invention. FIG. 3 is a schematic diagram of electrical connection of coils of a winding group according to an embodiment of the present invention. Taking FIGS. 2 and 3 as examples, the winding group 120 has four coils 121, 122, 123, and 124, which are connected in series (corresponding to FIG. 2) or in parallel (corresponding to FIG. 3).

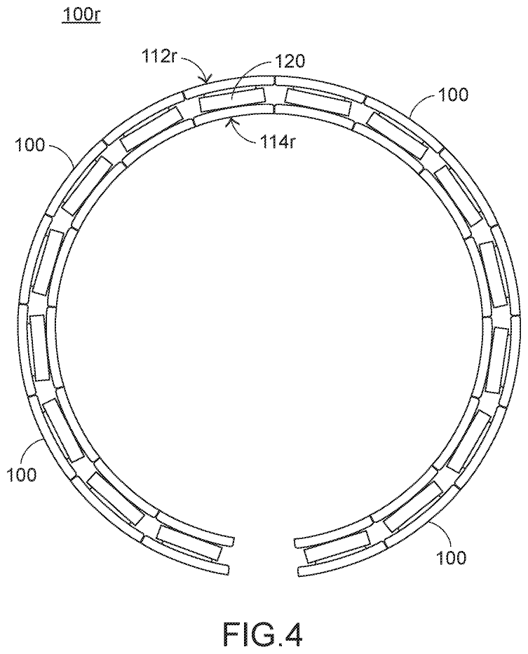

FIG. 4 is a schematic top view of a ring-shaped electromagnet according to an embodiment of the present invention. In some embodiments, as shown in FIG. 4, the magnetic attraction structure includes a plurality of electromagnets 100, and the electromagnets 100 are connected to each other to form a ring-shaped electromagnet 100r. In some embodiments, referring to FIGS. 1 and 4, the first plates 112 of the electromagnets 100 are connected to each other to form a first ring-shaped plate 112r, and the second plates 114 of the electromagnets 100 are connected to each other to form a second ring-shaped plate 114r. The term “connected to” mentioned here may be direct contact between the plates or the plates integrally formed. In some embodiments, the winding groups 120 of the electromagnets 100 are connected in series or in parallel.

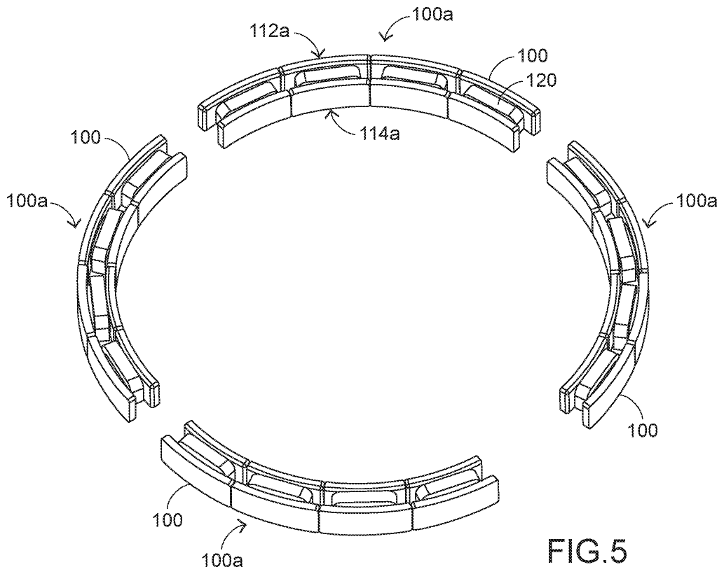

FIG. 5 is a schematic top view of arc-shaped electromagnets according to an embodiment of the present invention. In some embodiments, as shown in FIG. 5, the magnetic attraction structure includes a plurality of electromagnets 100, which are arranged to form a plurality of arc-shaped electromagnets 100a surrounding a region. In some embodiments, referring to FIGS. 1 and 5, the first plates 112 of the four electromagnets 100 are connected to each other to form a first arc-shaped plate 112a, and the second plates 114 of the four electromagnets 100 are connected to each other to form a second arc-shaped plate 114a. The term “connected to” mentioned here may be direct contact between the plates or the plates integrally formed. In some embodiments, the winding groups 120 of the four electromagnets 100 of one of the arc-shaped electromagnets 100a are connected in series or in parallel. In some embodiments, the winding groups 120 of two adjacent electromagnets 100 of two adjacent arc-shaped electromagnets 100a are connected in series or parallel.

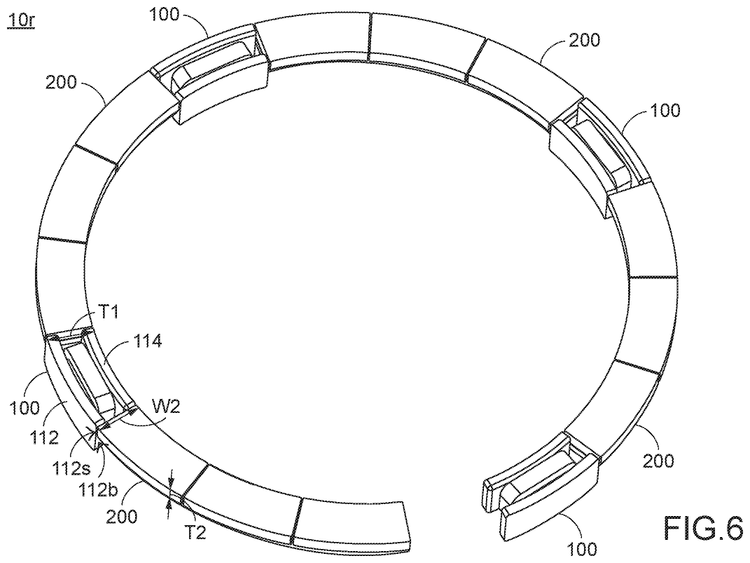

FIG. 6 is a schematic top view of a ring-shaped magnetic attraction structure according to an embodiment of the present invention. In some embodiments, as shown in FIG. 6, in addition to a plurality of electromagnets 100, the magnetic attraction structure further includes one or more permanent magnets 200, and the one or more permanent magnets 200 are disposed between two adjacent of the electromagnets 100. In some embodiments, the electromagnets 100 and the one or more permanent magnets 200 are arranged to form a ring-shaped magnetic attraction structure 10r.

In some embodiments, referring to FIGS. 1 and 6, one of the one or more permanent magnets 200 is adjacent to a side surface 112b of the short side 112s of the first plate 112 of one of the electromagnets 100 (or may be referred to as a thickness surface) and a side 114b of the short side 114s of the second plate 114 thereof (or may be referred to as a thickness surface). In some embodiments, the permanent magnet 200 is plate-shaped, and a side surface thereof (or may be referred to as thickness surfaces) is adjacent to the side surface 112b of the short side 112s of the first plate 112 of the electromagnet 100 and the side surface 114b of the short side 114s of the second plate 114 of the electromagnet 100. In some embodiments, the plane of the permanent magnet 200 is perpendicular or substantially perpendicular to the plane of the first plate 112 and/or the plane of the second plate 114. In some embodiments, a thickness T1 of the electromagnet 100 and a width W2 of the permanent magnet 200 are the same or substantially the same. In some embodiments, a thickness T2 of the permanent magnet 200 is less than the thickness T1 of the electromagnet

The above-mentioned magnetic attraction structure, such as the single electromagnet 100 shown in FIG. 1, the ring-shaped electromagnet 100r shown in FIG. 4, the arc-shaped electromagnet 100a (or may be referred to as a segmented electromagnet) shown in FIG. 5, the ring-shaped magnetic attraction structure 10r or a combination thereof, can be applied to the wireless charging device and/or the terminal device, and magnetic attraction force of the wireless charging device and/or magnetic attraction force of the terminal device can be adjusted by adjusting current of the electromagnet(s) 100.

The present invention further provides a wireless charging device. FIG. 7 is an exploded view of a wireless charging device and a terminal device according to an embodiment of the present invention. As shown in FIG. 7, the wireless charging device includes a magnetic attraction structure (herein taking the ring-shaped magnetic attraction structure 10r of FIG. 6 as an example), a cover plate 12, a charging module 14 and a bottom plate 16. The cover plate 12 is disposed over the magnetic attraction structure (e.g., the ring-shaped magnetic attraction structure 10r) and is configured to face (or contact) a terminal device 2. The charging module 14 is laterally adjacent to the magnetic attraction structure (e.g., the ring-shaped magnetic attraction structure 10r). The bottom plate 16 is disposed beneath the magnetic attraction structure (e.g., the ring-shaped magnetic attraction structure 10r) and the charging module 14. In some embodiments, the wireless charging device may be, for example, a daily consumer wireless charger, a car wireless charger, and the like. In some embodiments, the terminal device 2 includes the magnetic attraction structure (herein taking the ring-shaped electromagnet 100r of FIG. 4 as an example) and a cover plate 22 (or may be referred to as a lower housing). The terminal device 2 may be, for example, a mobile phone, a tablet, or the like.

In some embodiments, the charging module 14 is surrounded by the magnetic attraction structure (e.g., the ring-shaped magnetic attraction structure 10r). In some embodiments, the charging module 14 includes a charging coil 142, a ferrite magnetic sheet 144 and a printed circuit board assembly (PCBA) 146. The charging coil 142 is close to (or facing) the cover plate 12. The ferrite magnetic sheet 144 is disposed beneath the charging coil 142. The printed circuit board assembly 146 is disposed beneath the ferrite magnetic sheet 144. The ferrite magnetic sheet 144 is disposed between the charging coil 142 and the printed circuit board assembly 146.

It is worth noting that the wireless charging device includes the magnetic attraction structure and/or the terminal device 2 includes the magnetic attraction structure, and the magnetic attraction force can be automatically/semi-automatically/manually adjusted through characteristics of the electromagnet(s) and other technologies, such as distance sensing technology (e.g., AI smart, infrared sensing, camera, Bluetooth sensing, light sensitive response, Q-value sensing, other suitable distance sensing technology, or a combination thereof) and/or switch setting (e.g., a touch switch). As such, the user or the wireless charging device can control the magnetic attraction force between the wireless charging device and the terminal device according to actual needs to achieve the purpose of convenient use in various use environments. For example, in a vehicle-mounted environment, a magnetic force control button (which can be disposed on outside of the wireless charging device) can be touched to increase or decrease the magnetic attraction force, so as to realize temporary fixation or removal of the terminal device (e.g., the mobile phone). Therefore, it is not necessary to use a general clamp and manually assist in clamping and releasing the terminal device, which can improve safety and convenience of using the terminal device.

However, the above are only the preferred embodiments of the present invention, and should not be used to limit the scope of implementation of the present invention, that is, simple equivalent changes and modifications made in accordance with claims and description of the present invention are still within the scope of the present invention. In addition, any embodiment of the present invention or claim does not need to achieve all the objectives or advantages disclosed in the present invention. In addition, the abstract and the title are not used to limit the scope of claims of the present invention.

What is claimed is:

1. A magnetic attraction structure for a wireless charging device or a terminal device, comprising:
one or more electromagnets, the electromagnet comprising an iron core and a winding group, and the iron core comprising a first plate, a second plate and a connecting part, and the first plate being separated from the second plate by a distance, and the connecting part being connected between the first plate and the second plate, and the winding group surrounding the connecting part, wherein a side surface of a long side of the first plate and a side surface of a long side of the second plate are configured to face a cover plate of the wireless charging device or a cover plate of the terminal device.

2. The magnetic attraction structure of claim 1, wherein the electromagnet is I-shaped in a cross section perpendicular to a plane direction of the first plate and a plane direction of the second plate.

3. The magnetic attraction structure of claim 1, wherein the winding group has a plurality of coils connected in series or in parallel.

4. The magnetic attraction structure of claim 1, wherein the one or more electromagnets are the electromagnets, and the electromagnets are connected to each other to form a ring-shaped electromagnet.

5. The magnetic attraction structure of claim 4, wherein the first plates of the electromagnets are connected to each other to form a first ring-shaped plate, and the second plates of the electromagnets are connected to each other to form a second ring-shaped plate.

6. The magnetic attraction structure of claim 1, wherein the one or more electromagnets are the electromagnets, and the electromagnets are arranged to form a plurality of arc-shaped electromagnets surrounding a region.

7. The magnetic attraction structure of claim 1, further comprising one or more permanent magnets, wherein the one or more electromagnets are the electromagnets, and the one or more permanent magnets are disposed between two adjacent of the electromagnets.

8. The magnetic attraction structure of claim 7, wherein the electromagnets and the one or more permanent magnets are arranged to form a ring-shaped magnetic attraction structure.

9. The magnetic attraction structure of claim 7, wherein one of the one or more permanent magnets is adjacent to a side surface of a short side of the first plate of one of the electromagnets and a side surface of a short side of the second plate of the one of the electromagnets.

10. A wireless charging device, comprising:
the magnetic attraction structure of claim 1;
a cover plate disposed over the magnetic attraction structure and configured to face a terminal device;
a charging module laterally adjacent to the magnetic attraction structure; and
a bottom plate disposed beneath the magnetic attraction structure and the charging module.

11. The wireless charging device of claim 10, wherein the charging module is surrounded by the magnetic attraction structure, and the charging module comprises:
a charging coil close to the cover plate;
a ferrite magnetic sheet disposed beneath the charging coil; and
a printed circuit board assembly (PCBA) disposed beneath the ferrite magnetic sheet.
